(19) United States
(12) Patent Application Publication
(10) Pub. No.: US 2023/0312168 A1
(43) Pub. Date: Oct. 5, 2023

(54) PORTABLE LEAK-PROOF CONTAINER

(71) Applicant: 101 Source Corp., Encinitas, CA (US)

(72) Inventors: Matt Green, Vancouver, WA (US); Justin Wade Marlett, San Diego, CA (US)

(21) Appl. No.: 18/192,477

(22) Filed: Mar. 29, 2023

Related U.S. Application Data
(60) Provisional application No. 63/327,765, filed on Apr. 5, 2022.
(60) Provisional application No. 63/406,435, filed on Sep. 14, 2022.
(60) Provisional application No. 63/482,520, filed on Jan. 31, 2023.

(51) Int. Cl. B65D 6/00; B65D 25/28; B65D 63/10; B65D 25/34

(52) U.S. Cl. CPC B65D 11/10; B65D 25/2873; B65D 11/20; B65D 63/10; B65D 25/34

(57) ABSTRACT

Briefly, a portable leak-proof container for liquid and/or solid materials is disclosed. In particular embodiments, the container may include a substantially planar base that is circular in shape and a plurality of panels abutting the substantially planar base, in which the plurality of panels are encased within a wall having a truncated cone shape. The wall having the truncated cone shape may be fused with the substantially planar base.

This patent application claims the benefit of U.S. Provisional Patent Application No. 63/327,765, filed Apr. 5, 2022, U.S. Provisional Patent Application No. 63/406,435, filed Sep. 14, 2022, and U.S. Provisional Patent Application No. 63/482,520, filed Jan. 31, 2023, which are incorporated herein by reference in their entirety.

### BACKGROUND

### 1. Field

The present disclosure relates generally to containers, such as that may be utilized to collect and/or contain various debris or other materials, which may include liquid and/or solid construction debris, hazardous materials, and so forth.

### 2. Information

At times, it may be useful to, and/or in some instances required, to utilize a relatively large, leak-proof container. For example, at a commercial or residential construction site, a “concrete washout” container may be utilized to hold unused concrete slurry until such material can be hauled away and properly disposed of. In other instances, again, which may occur at a commercial or residential construction site, remnants of paint, coatings, caulking, or other materials may require containment prior to specialized disposal. In still other instances, such as may occur when dealing with hazardous materials, various cleanup products, which may include diluted or treated hazardous materials, may require their safe collection as well as temporary storage prior to appropriate and/or lawful disposal.

In these instances, and others, a construction site manager, hazardous material specialist, etc., may utilize a specialized construction debris/hazardous materials container. However, typical containers may be bulky and/or require some amount of assembly at a construction site (or site of a hazardous materials spill, etc.). Further, typical containers may also utilize an internal lining so as to control leakage or leaching of materials from the container into the surrounding area. For these reasons, and others, development of leak-proof containers, such as to collect and/or contain hazardous or other materials continues to be an active area of investigation.

### SUMMARY

One general aspect includes a portable leak-proof container for substantially liquid and/or solid materials, the container comprising a substantially planar base having an outer circumference or perimeter that is substantially circular in shape. The container may additionally include a plurality of panels abutting the substantially circular base, in which the plurality of panels being individually encased within a plurality of wall compartments of a wall having a truncated cone shape, wherein the wall having the truncated cone shape is fused with at least the substantially planar base at the outer circumference or perimeter.

In particular embodiments, the truncated cone shape may include an angle having a pitch of between 30° and 85° relative to the plane of the substantially planar base. In particular embodiments, the truncated cone shape includes an angle having a pitch of between 60° and 80° relative to the plane of the substantially planar base. In particular embodiments, the truncated cone shape includes an angle having a pitch of between 65° and 75° relative to the plane of the substantially planar base. In particular embodiments, the truncated cone shaped is fused with the substantially planar base via radiofrequency welding. In particular embodiments, the container may further include one or more fasteners, coupled to the wall having the truncated cone shape, to retain a cover over a top portion of the container. In particular embodiments, the container may additionally include one or more eyelets to accommodate a corresponding number of stakes, the corresponding number of stakes to restrict movement of the container with respect to a supporting surface. In particular embodiments, the wall having the truncated cone shape may include a material having a tensile strength of between about 6700 N (about 1500 pounds) and 13,500 N (about 3113 pounds). In particular embodiments, the container is suitable for retaining concrete suspended in a liquid medium or for containing a slurry material. In particular embodiments, the plurality of panels abutting the substantially round base are substantially rectangular in shape. In particular embodiments, the wherein the container comprises at least a substantial percentage of polyvinyl chloride (PVC) and/or at least a substantial percentage of tarpaulin, depending on an embodiment.

Another general aspect includes a method for erecting a container for debris, the method comprising unfolding, substantially without use of machinery or equipment, the container from a compressed to an uncompressed state and positioning the container at a location for intended use and without insertion of additional structural elements.

In particular embodiments, the method additionally includes grasping and/or pulling on one or more straps to relocate the container.

Another general aspect includes a method for forming a container to accommodate debris, which includes disposing a plurality of rectangular-shaped panels into a wall having a truncated cone shape and fusing the wall to a planar and substantially circular base so as to form a substantially leak-proof seal at fusing points or seams.

In particular embodiments, the fusing points or seams are between the wall and the substantially circular base. In particular embodiments, fusing the wall to the planar and substantially circular base includes radio frequency welding the wall to the planar and substantially circular base. In particular embodiments disposing the plurality of rectangular-shaped panels includes disposing corrugated plastic rectangular-shaped panels into the wall having the truncated cone shape.

In particular embodiments erecting the wall having the truncated cone shape include erecting a cone-shaped wall having a pitch of between about 30° and 85° relative to the plane of the planar and substantially circular base. In particular embodiments, the truncated cone-shaped may include a pitch of between about 60° and 75° relative to the plane of the planar and substantially circular base. In particular embodiments, the method may additionally include comprising refraining from inserting any additional structural components into the container to accommodate the debris. In particular embodiments, the method may additionally include allowing the container and/or cover to accommodate the debris to unfold itself without substantial user input. In particular embodiments, the method may additionally include displacing the container responsive to grasping one or more straps of the container.

Another general aspect includes a portable leak-proof container for substantially liquid and/or solid materials, the container including a substantially planar base having an outer circumference or perimeter that is substantially circular in shape. The portable leak-proof container also includes a plurality of panels abutting the substantially circular base, the plurality of panels being individually encased within a plurality of wall compartments of a wall having a truncated cone shape. The portable leak-proof container also includes a self-erecting moisture-shedding cover to be placed in contact with the substantially planar base.

In particular embodiments, the self-erecting moisture-shedding cover includes two or more flexible ribs, the two or more flexible ribs being prestressed to maintain an arc or dome shape responsive to deployment. In particular embodiments, the self-erecting moisture-shedding cover includes a skirt, which operates to provide a path for rain shedding below a lip of the substantially planar base. In particular embodiments, the two or more flexible ribs crossover at a location at a base portion of the self-erecting moisture-shedding cover. In particular embodiments, the portable leak-proof container further includes a tensioner to retain in place the crossover at the location at the base portion of the self-erecting moisture-shedding cover.

Another general aspect includes a cover, which includes a base portion, the base portion having a crossover of two or more structural ribs, the two or more structural ribs extending from the base portion to an apex portion of the cover, an area between two or more structural at the apex portion of the cover providing an open region to channel liquid incident at the apex portion of the cover.

In particular embodiments, the two or more structural ribs are prestressed so as to form the apex portion of the cover substantially without user manipulation. In particular embodiments, the two or more structural ribs define an arc or dome shape. In particular embodiments, the two or more structural ribs are held into place by a tensioner at opposed sides of the base portion of the cover. In particular embodiments, the base portion of the cover includes provisions for fastening the cover to a circle-shaped container. In particular embodiments, the cover forms a relatively tight seal around the lip of the portable leak-proof container, which may reduce possibility of potential spilling of material within the container.

In particular embodiments, a portable leak-proof container may include a plurality of straps, wherein for individual straps of the plurality of straps, a portion may be affixed to at least the substantially planar base. In implementations, for individual straps of the plurality of straps, an additional portion may be affixed to one or more of the plurality of panels abutting the substantially circular base. In implementations, one or more of the plurality of straps may comprise a loop. In particular embodiments, the plurality of straps may comprise nylon or polyester, or a combination thereof. In implementations, the plurality of straps may be affixed to the substantially planar base and/or at least one of the plurality of panels abutting the substantially circular base via respective lengths of polyvinyl chloride and/or tarpaulin RF welded to the substantially planar base and/or at least one of the plurality of panels abutting the substantially circular base. In implementations, the plurality of straps may be sewn onto the respective lengths of polyvinyl chloride and/or tarpaulin.

For particular embodiments, a portable leak-proof container for substantially liquid and/or solid materials may include a substantially planar base having an outer circumference or perimeter that is substantially circular in shape, a plurality of panels abutting the substantially circular base, the plurality of panels being individually encased within a plurality of wall compartments of a wall having a truncated cone shape; and a plurality of straps, wherein for individual straps of the plurality of straps, a portion is affixed to at least the substantially planar base. In implementations, for individual straps of the plurality of straps, an additional portion may be affixed to the wall having the truncated cone shape. Also, in implementations, one or more of the plurality of straps may comprise a loop. In implementations, the plurality of straps may comprise nylon or polyester, or a combination thereof. In embodiments, the plurality of straps may be affixed to the substantially planar base and/or the wall having the truncated cone shape via respective lengths of polyvinyl chloride and/or tarpaulin RF welded to the substantially planar base and/or the wall having the truncated cone shape, wherein the plurality of straps may be sewn onto the respective lengths of polyvinyl chloride and/or tarpaulin.

In implementations, the substantially planar base may comprise a diameter of approximately five feet and the plurality of straps may comprise six straps. Also, in implementations, the six straps may be arranged into three loops. In particular implementations, the substantially planar base may comprise a diameter of approximately seven feet and the plurality of straps may comprise eight straps. In implementations, the eight straps may be arranged into four loops.

For particular embodiments, a method for forming a container to accommodate debris or other material may include disposing a plurality of substantially rectangular-shaped panels into a wall having a truncated cone shape, fusing the wall to a planar and substantially circular base so as to form a substantially leak-proof seal at fusing points or seams, and forming a plurality of straps to facilitate lifting and/or suspension of the container. In implementations, forming the plurality of straps may include sewing the plurality of straps to respective lengths of polyvinyl chloride and/or tarpaulin and affixing the lengths of polyvinyl chloride and/or tarpaulin to at least the substantially circular base. In implementations, forming the plurality of straps may further include affixing the lengths of polyvinyl chloride and/or tarpaulin to the wall having the truncated cone shape. Also, in implementations, forming the plurality of straps may further include forming the plurality of straps of nylon and/or polyester.

### DESCRIPTION OF THE DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is a view of a container having a truncated cone-shaped wall, according to an embodiment.

FIG. 2 is a view showing the bottom of a container having a truncated cone-shaped wall, according to an embodiment.

FIG. 3 is a view showing a cross-section of a truncated cone-shaped wall of a container, along with a sample corrugated plastic panel for insertion into the truncated cone-shaped wall, according to an embodiment.

FIG. 4 shows panels that form a truncated cone-shaped wall of a container according to an embodiment.

FIG. 5 is a view of a container having a truncated cone-shaped wall and a covering, according to an embodiment

FIG. 6 is a flowchart for a method for erecting a container having a truncated cone-shaped wall, according to an embodiment.

FIG. 7 is a flowchart for a method for forming a container to accommodate debris, according to an embodiment.

FIGS. 8 and 9 show a container having a truncated cone-shaped wall in a folded state, according to an embodiment.

FIG. 10 shows a container having a slightly different shape, according to an embodiment.

FIG. 11 shows the container of FIG. 10 with a precipitation cover, according to an embodiment.

FIG. 12 shows a self-erecting moisture-shedding cover that may be attached to a portable leak-proof container, according to an embodiment.

FIG. 13 shows a reverse side of the self-erecting moisture-shedding cover of FIG. 12, according to an embodiment.

FIG. 14 shows a base portion and an apex portion of the self-erecting moisture-shedding cover of FIG. 12, according to an embodiment.

FIG. 15 shows a close-up view of structural ribs crossover (1320) according to an embodiment 1500.

FIG. 16 is a view of a container having a truncated cone-shaped wall and having a plurality of straps, according to an embodiment.

FIG. 17 is a view showing the bottom of a container having a truncated cone-shaped wall and also showing portions of multiple straps affixed to the bottom of the container, according to an embodiment.

FIG. 18 depicts a container being lifted via a forklift as facilitated by a plurality of straps affixed to the container, according to an embodiment.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others, one or more aspects, properties, etc. may be omitted, such as for ease of discussion, or the like. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents.

### DETAILED DESCRIPTION

References throughout this specification to one implementation, an implementation, one embodiment, an embodiment, and/or the like means that a particular feature, structure, characteristic, and/or the like described in relation to a particular implementation and/or embodiment is included in at least one implementation and/or embodiment of claimed subject matter. Thus, appearances of such phrases, for example, in various places throughout this specification are not necessarily intended to refer to the same implementation and/or embodiment or to any one particular implementation and/or embodiment. Furthermore, it is to be understood that particular features, structures, characteristics, or the like described are capable of being combined in various ways in one or more implementations and/or embodiments and, therefore, are within intended claim scope. In general, of course, for the specification of a patent application, these and other issues have a potential to vary in a particular context of usage. In other words, throughout the disclosure, particular context of description and/or usage provides helpful guidance regarding reasonable inferences to be drawn; however, likewise, “in this context” in general without further qualification refers at least to the context of the present patent application.

Some example methods, apparatuses, and/or articles of manufacture are disclosed herein, which may be used, in whole or in part, to facilitate and/or support one or more operations and/or techniques for manufacturing and/or utilizing a portable leak-proof container. As will be discussed in greater detail below, in some instances, a portable leak-proof container may be employed, in whole or in part, to collect liquid and/or solid materials, such as from pollutant-generating activities on construction sites, just to illustrate one possible use case or scenario (e.g., “washout” or “clean out”), for example. As will also be seen, at times, a portable leak-proof container may be implemented, in whole or in part, as having a truncated cone-shaped wall, for example. Embodiments of claimed subject matter may function to store debris, such as liquid and/or solid construction debris, hazardous materials, and so forth. As will be seen, in some instances, embodiments and/or methods of use and/or manufacture of a container having a truncated cone-shaped wall may operate to provide a substantially leak-proof approach to storage of liquid and/or at least partially liquid, debris. In addition, a container having a truncated cone-shaped wall in accordance with particular embodiments of claimed subject matter may require virtually no on-site assembly. In a particular embodiment, as will be described herein, construction personnel and/or hazardous material personnel, may simply unfold the container having a truncated cone-shaped wall from a compressed state to an uncompressed state, without insertion of brackets, retainers, inserts, or any other structural members prior to use of the container. This may represent an improvement over conventional debris containers in which a separate liner may be required, so as to retain liquid debris, for example, in a leak-proof manner. Further, such containers may represent an improvement over typical containers that require on-site assembly, such as insertion of structural members, brackets, retainers, and so forth.

In this context a “container” refers to a receptacle having a circular or elliptical planar base upon which tapered or truncated cone-shaped walls may be fused to the circular or elliptical planar base. In particular embodiments, such fusing of the truncated cone-shaped walls to the circular or elliptical planar base may be achieved utilizing radiofrequency (RF) welding, in which a thermoplastic material is fused together at various points between the circular or elliptical planar base and the tapered or truncated cone-shaped walls. Such fusing may utilize a relatively high power, high-frequency signal (e.g., approximately 10.0 MHz to approximately 100.0 MHz) in which an oscillating electric field gives rise to oscillations of polar molecules of certain thermoplastics responsive to the time-varying electric field. Such oscillations may bring about temperature increases, which results in melting of the thermoplastic materials. It should be noted that claimed subject matter is intended to embrace RF welding, as well as other techniques, which may be utilized to form a fused leak-proof seal between walls of a container and a base of the container.

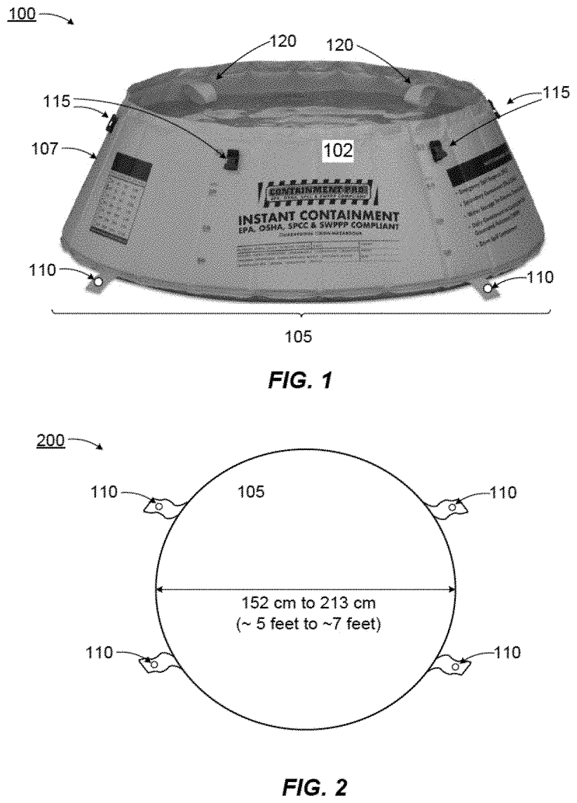

FIG. 1 is a view of a container having a truncated cone-shaped wall, according to an embodiment 100. In the embodiment of FIG. 1, container 102 is shown retaining liquid, such as water, in a leakproof manner. In particular embodiments, such leakproof retaining of liquid material may be brought about via a manufacturing process, which may include RF welding, in which materials of circular base 105 are fused to truncated cone-shaped wall 107. Accordingly, as previously indicated, container 102 does not require a separate inner liner to ensure that liquids contained within container 102 do not escape into the surrounding area.

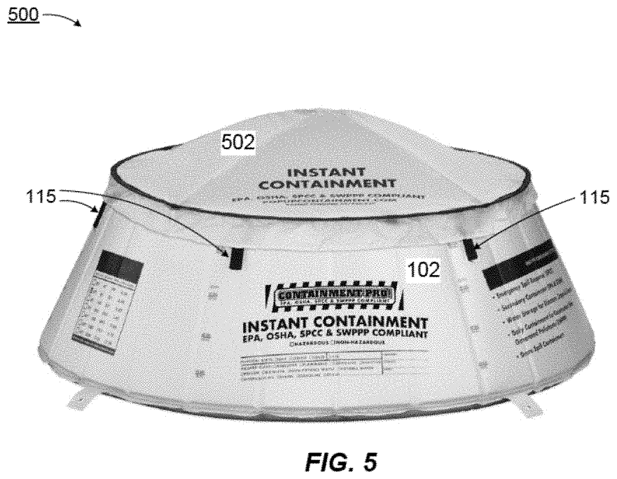

The embodiment of FIG. 1 also shows eyelets 110, which may be fastened within strips which extend from circular base 105. In particular embodiments, eyelets 110 may be formed from any suitable metal or metal alloy, so as to permit container 102 to be staked into place, thereby preventing container 102 to be moved and/or carried by high winds when empty. Container 102 is also shown as including fasteners 115, which may operate to secure a cover, such as cover 502, discussed in relation to FIG. 5 (herein). Container 102 is also shown as including straps 120, which may operate as handles, thereby allowing personnel to reorient and/or displace the container, such as prior to the container being filled with, construction debris, hazardous material, etc.

In particular embodiments, container 102, circular base 105, fasteners 115, straps 120 and other components of the embodiment of FIG. 1 may comprise a high-strength thermoplastic material. In particular embodiments, the high-strength thermoplastic material may possess (or comprise) a tensile strength of between about 6700 N (about 1500 pounds) and about 13,500 N (about 3113 pounds). However, claimed subject matter is intended to embrace various embodiments, such as containers having walls comprising or possessing a tensile strength of less than 6700 N, for example, and containers having walls comprising or possessing a tensile strength of greater than 13,500 N. In particular embodiments, one or more of container 102, circular base 105, fasteners 120, and/or other components of the embodiment of FIG. 1 may comprise at least a substantial percentage (e.g. 50%) of polyvinyl chloride, tarpaulin, or a combination thereof, depending on an embodiment.

FIG. 2 is a view showing the bottom of a container having a truncated cone-shaped wall, according to an embodiment 200. As shown in FIG. 2, circular base 105 may accommodate one or more strips, in which the one or more strips may comprise eyelet 110, which may permit the container to be staked down and thus held into place prior to partially or completely filling the container with liquid or solid material. In particular embodiments, eyelets 110 may comprise a diameter of between 1 cm and 5 cm, so as to accommodate a variety of sizes of stakes that operate to fasten or hold the container into place. In particular embodiments, circular base 105 may comprise a diameter of between about 152 cm (about 5.0 feet) to about 213 cm (about 7.0 feet). It should be noted that in various embodiments, containers having a width of between about 152 cm and about 213 cm are suitable for placement onto a flatbed truck or within the walls of a pickup truck. Such sizes represent a balance between containers that are large enough to store an appreciable amount of liquid or solid debris without being so large as to represent an unwieldy container that is too heavy to transport to an appropriate waste disposal site, for example.

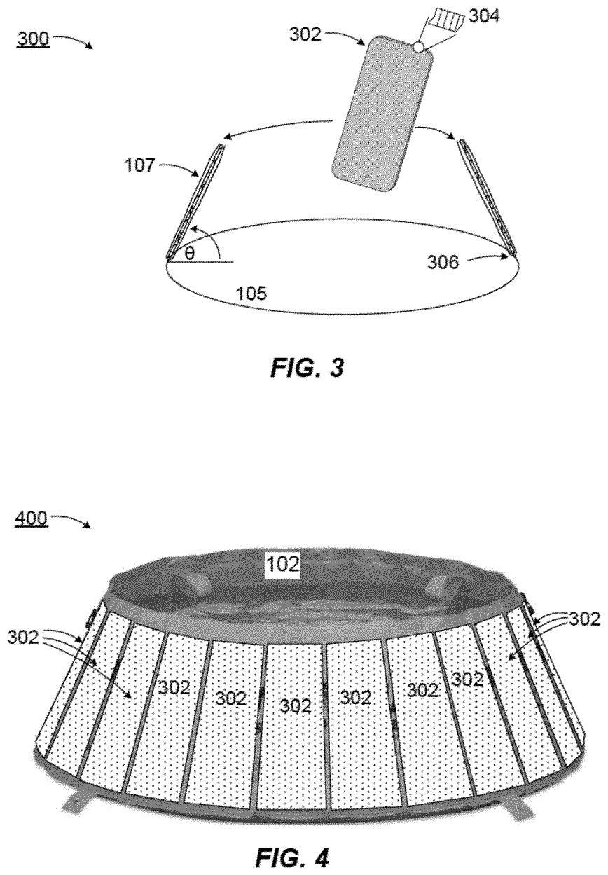

FIG. 3 is a view showing a cross-section a truncated cone-shaped wall of a container, along with a sample corrugated plastic panel for insertion into the truncated cone-shaped wall, according to an embodiment 300. As shown in FIG. 3, tapered or truncated cone-shaped wall 107 may be arranged at a pitch angle Θ measured with respect to the plane of circular base 105. In particular embodiments, pitch angle θ may comprise an angle of between about 30° and about 85° with respect to the plane of circular base 105. In particular other embodiments, pitch angle Θ may comprise an angle of between about 60° and about 80° relative to the plane of circular base 105. In particular other embodiments, pitch angle Θ may comprise an angle of between about 65° and about 75°. It should be noted that claimed subject matter is intended to embrace pitch angle Θ comprising other values, virtually without limitation.

FIG. 3 additionally shows a cross-section of a portion of truncated cone-shaped wall 107 having plastic panel 302, which abuts circular base 105. In the embodiment of FIG. 3, plastic panel 302 may comprise a thin corrugated plastic panel that is inserted into (and encased within) truncated cone-shaped wall 107 during a manufacturing process. Accordingly, as previously mentioned herein, unfolding container 102, such as from a compressed state to an uncompressed state, may involve little or no effort. As indicated at 304, plastic panel 302 may comprise corrugated plastic. However, in other embodiments, plastic panel 302 may comprise a solid plastic panel, or a combination of corrugated portions and solid portions.

In FIG. 3, area 306 indicates a location at which circular base 105 has been fused, such as via RF welding, for example, to truncated cone-shaped wall 107. (Of course, all, or substantially all, of cone-shaped wall 107 may be RF welded to substantially all of the perimeter of circular base 105, thus ensuring a completely leakproof seal between wall 107 and circular base 105.)

FIG. 4 shows panels that form a truncated cone-shaped wall of a container according to an embodiment 400. In FIG. 4, an outer covering of compartments within cone-shaped wall 107 have been removed, so as to expose a plurality of plastic panels 302, which abut circular base 105. Plastic panel 302 may be arranged around the circumference of truncated cone-shaped wall 107, so as to provide rigidity to the cone-shaped wall. It may be appreciated that such an arrangement of plastic panels, within wall compartments of container 102, provides an ability for container 102 to maintain shape whether container 102 is empty, partially full or substantially full with either liquid, slurry, or solid material.

FIG. 5 is a view of the container having a truncated cone-shaped wall and a covering, according to an embodiment 500. In FIG. 5, cover 502 is shown as being retained via fasteners 115 to truncated cone-shaped wall 107 of container 102. In particular embodiments, attaching cover 502 may provide increased isolation of hazardous materials (or other materials) contained within container 102 from an external environment.

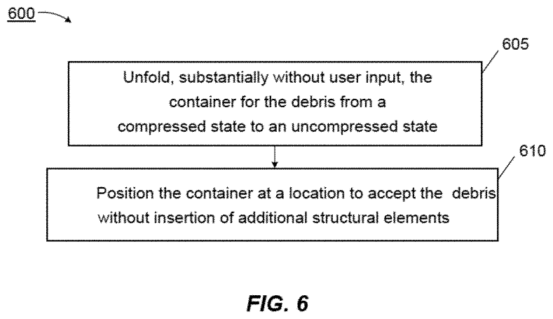

FIG. 6 is a flowchart for a method for erecting a container having a truncated cone-shaped wall, according to an embodiment 600. The method of FIG. 6 may begin at 605, which includes unfolding, substantially without use of machinery, such as cranes, forklifts, or the like, the container for debris from a compressed state to an uncompressed state. At 610, the container may be positioned at a location to accept debris without insertion of additional structural elements, such as brackets, retainers, struts, etc.

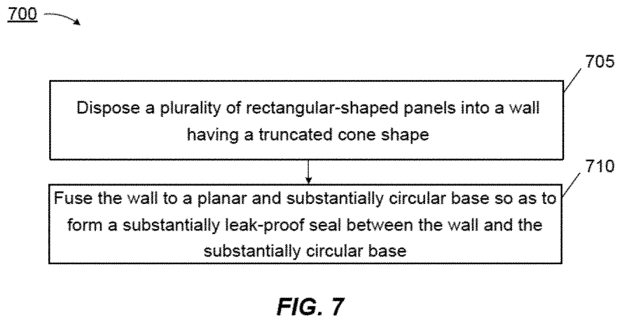

FIG. 7 is a flowchart for a method for forming a container to accommodate debris, according to an embodiment 700. The method of FIG. 7 may begin at 705, which includes disposing a plurality of rectangular-shaped panels into compartments of a wall having a truncated cone-shaped such as during a manufacturing process. The method may continue at 710, which may include fusing, such as by RF welding, the truncated cone-shaped wall to a circular base so as to form a substantially leakproof seal between the wall and the substantially circular base.

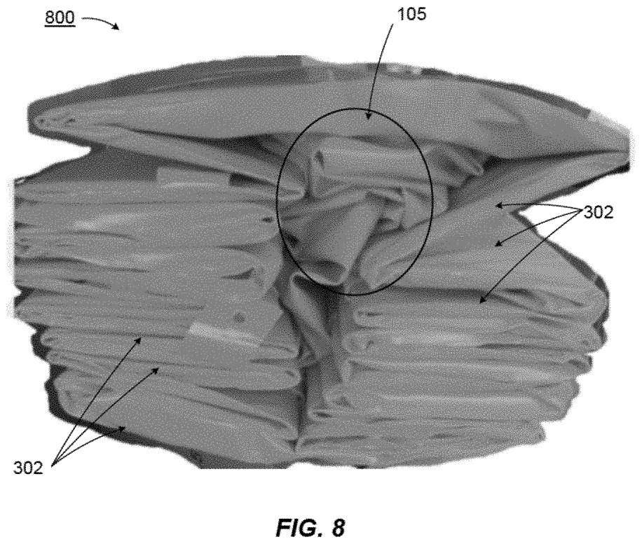

FIG. 8 shows a container having a truncated cone-shaped wall in a folded state, according to an embodiment 800. In FIG. 8, panels 302 can be seen as being encased within compartments of the thermoplastic walls of the container. Additionally, toward the center of FIG. 8, circular base 105 can be seen in a folded state. It may be appreciated that responsive to natural stresses among the components of the container shown in FIG. 8, the container may be capable of configuring itself in response to removal of packaging material utilized to confine the container in a folded state. Accordingly, in particular embodiments, construction personnel need only place the container of FIG. 8 on a surface and allow the container to bring itself to a state that approximates the unfolded state shown in FIG.

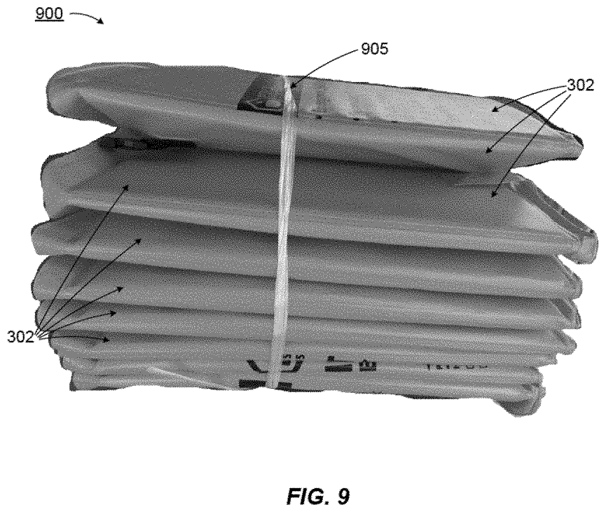

FIG. 9 shows a container having a truncated cone-shaped wall in a folded state, in accordance with an embodiment 900. In FIG. 9, cord 905 can be seen as retaining the container in a folded state. FIG. 9 additionally shows panels 302 encased within the various compartments of the container. It may be appreciated that simply by severing cord 905, container of FIG. 9 may be allowed to expand without use of machinery, such as cranes, mechanical levers, etc.

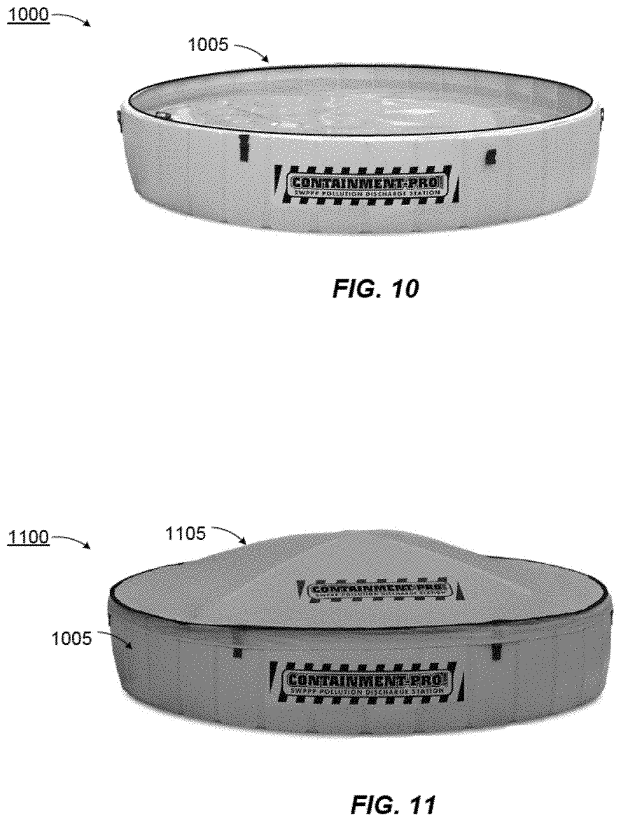

FIG. 10 shows a container having a slightly different shape, according to an embodiment 900. The container of embodiment 1000 may include rope 1005 or other type of high-strength material around an inner portion of the upper lip of the container. The container of embodiment 1000 may comprise a circular base having a diameter of between 152 cm (about 5 feet) and about 213 cm (about 7 feet). Additionally, the circular base of the container of embodiment 1000 may be fused with the vertical wall of the container by way of, for example, RF welding. However, fusing or coupling of the circular base of the container of embodiment 1000 with the vertical wall of the container may be achieved utilizing approaches other than RF welding.

FIG. 11 shows the container of FIG. 10 with a precipitation cover, according to an embodiment 1100. It may be appreciated that precipitation cover 1105 assists in isolating the contents of the container from the external environment.

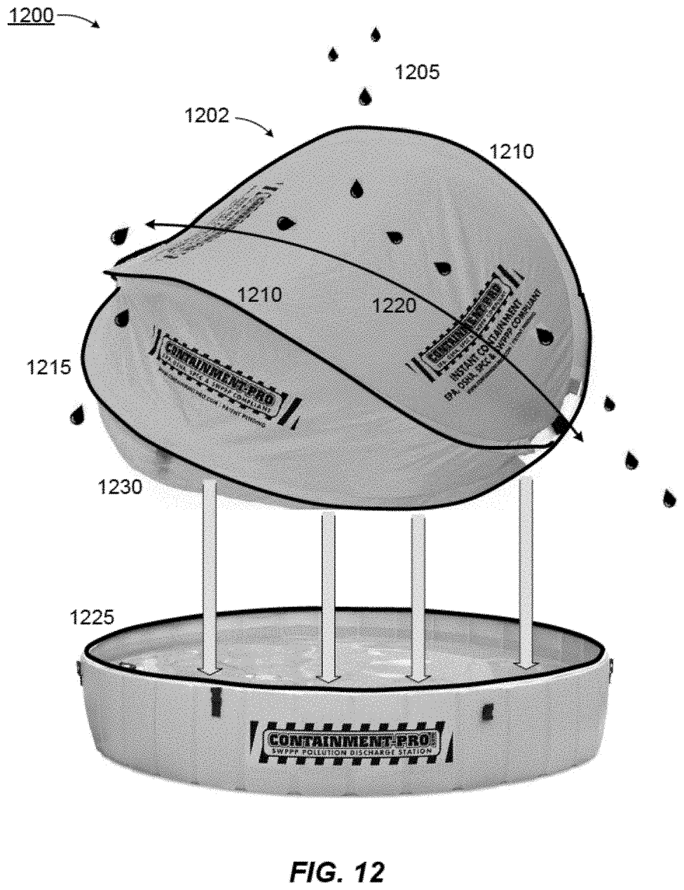

FIG. 12 shows a self-erecting moisture-shedding cover that may be attached to a portable leak-proof container, according to an embodiment 1200. Thus, the self-erecting moisture-shedding cover of FIG. 12 may be fastened to the container shown in embodiment 100 (FIG. 1) or may be fastened to the container of FIG. 11. In embodiment 1200, self-erecting moisture-shedding cover 1202 comprises two or more flexible, structural ribs 1210, which may be prestressed in a direction that forms an arc or dome shaped cover. In this context, the term “self-erecting”represents a cover, such as for use with a portable leak-proof container, that is formed without substantial user manipulation. For example, formation of an at an upper portion of the arc or dome shaped cover apex, such as shown in FIG. 12, may occur without substantial user manipulation. For example, in an embodiment, a user need only place the self-erecting moisture-shedding cover onto a portable leak-proof container, such as container 102 shown in FIG. 1. It may be appreciated that at least particular embodiments, use of a self-erecting moisture-shedding cover represents an improvement over precipitation cover 1105 (FIG. 11) since rain or other liquids may be easily channeled from an apex portion of the cover, toward the side portions of the cover, and away from the cover and container. As shown in FIG. 12, each of flexible, structural ribs 1210 operate to define an apex wherein, between each apex, an open channel may be formed. Thus, as shown, moisture droplets 1205, which may impinge or be incident upon the self-erecting moisture-shedding cover can be channeled either to a first side or to an opposite side, thereby prohibiting pooling of rain or other liquid on a surface of the cover.

As depicted in FIG. 12, flexible, structural ribs may permit fastening of cover 1202 to portable leak-proof container. Skirt 1230 of cover 1202 may be draped over a top portion of the leakproof container, so as to further assist in channeling raindrops, for example, toward a perimeter and away from the leak-proof container. In particular embodiments, when in an erected position, cover 1202 may be comparable in diameter to the containers shown in FIG. 1 and/or in FIG. 11. Thus, cover 1202 may embody a weather-resistant cover that keeps hazardous materials isolated from an external environment.

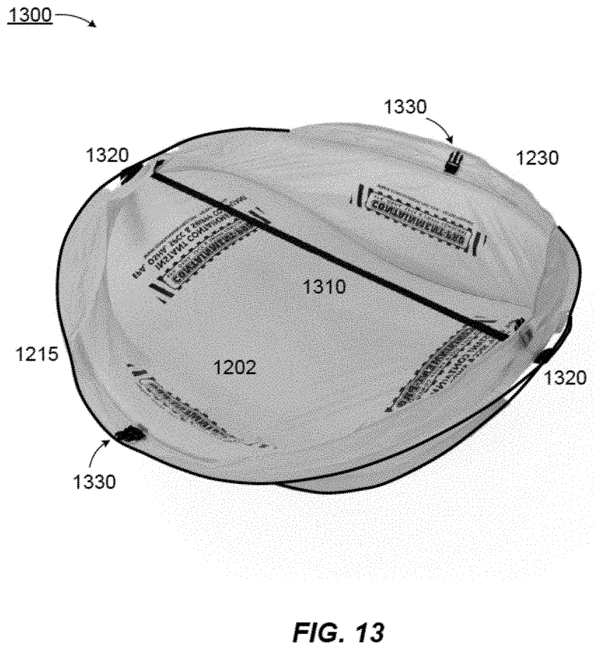

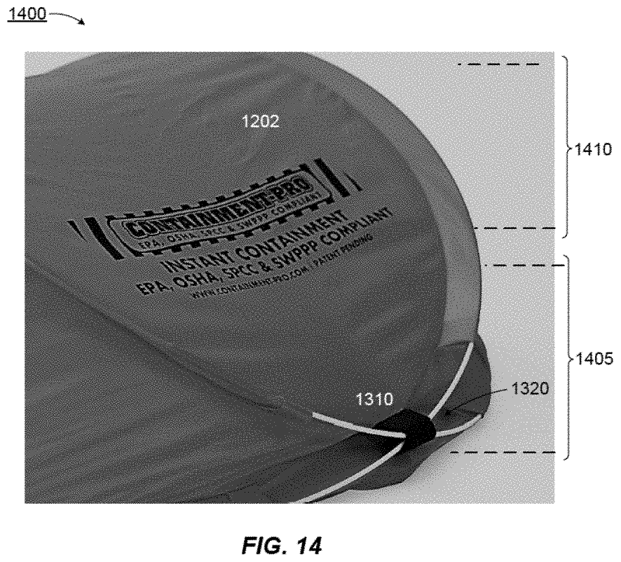

FIG. 13 shows a reverse side of the self-erecting moisture-shedding cover of FIG. 12, according to an embodiment 1300. As shown in FIG. 13 cover 1202 may comprise tensioner 1310. Tensioner 1310 may comprise a loop at opposite ends of the tensioner, wherein the loop surrounds and restrains a crossover region of the flexible, structural ribs (described in greater detail in reference to FIG. 14). Accordingly, before and after deployment, the loop regions of tensioner 1310 ensure that the crossover point of the flexible, structural ribs maintains its position with respect to other components of the self-erecting moisture-shedding cover. In particular embodiments, tensioner 1310 is fastened (or sewn) near a perimeter portion of cover 1202, such as nearby structural rib crossover 1320. Thus, a middle portion of tensioner 1310 may remain unconstrained, and can thereby be utilized to assist in restraining the cover in a folded position.

FIG. 14 shows a base portion and an apex portion of the self-erecting moisture-shedding cover of FIG. 12, according to an embodiment 1400. As shown in embodiment 1400, structural ribs crossover 1320 is held into place by way of the loop area of tensioner 1310. In particular embodiments, structural ribs crossover 1320 is located at base portion 1405 of cover 1202, in a region away from apex portion 1410. For example, in an embodiment, base portion 1405 is located at a lower region of cover 1202, while apex portion 1410 is located at an upper region of cover 1202.

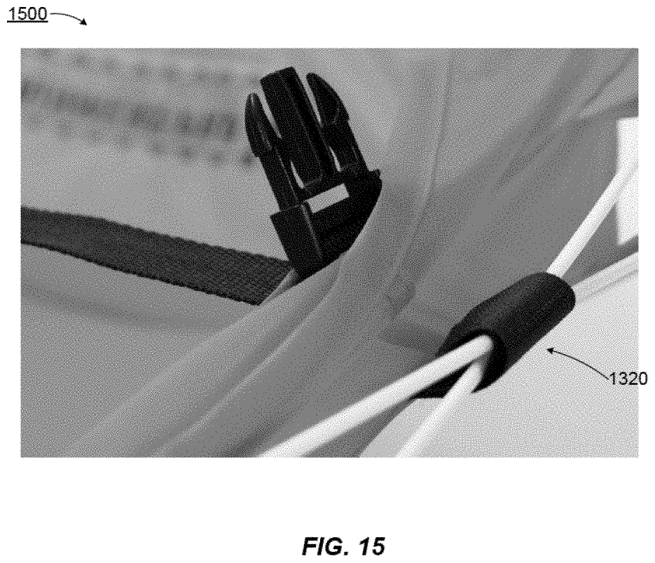

FIG. 15 shows a close-up view of structural ribs crossover (1320) according to an embodiment 1500.

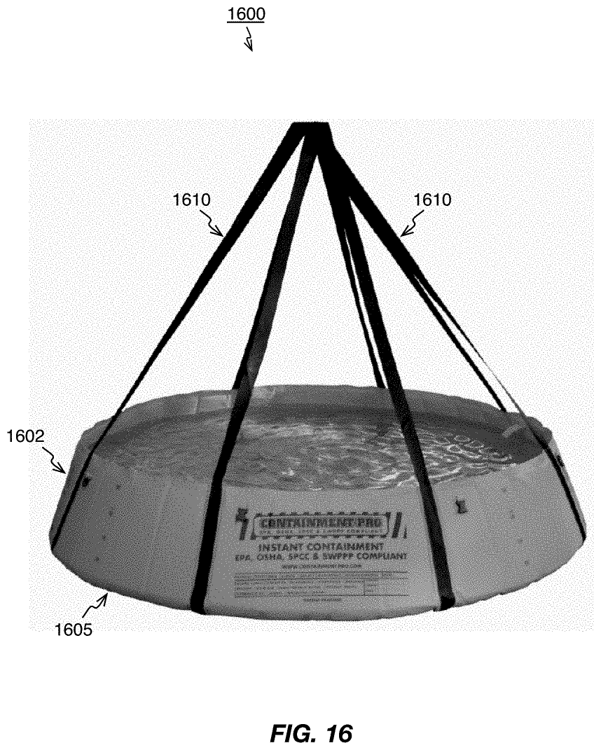

FIG. 16 is a view of a container 1602 having a truncated cone-shaped wall, according to an embodiment 1600. In particular implementations, embodiment 1600 may include at least some characteristics of embodiment 100 depicted in FIG. 1 and discussed above, although subject matter is not limited in scope in this respect. In embodiment 1600, container 1602 is shown retaining liquid, such as water, in a leakproof manner, although subject matter is not limited in scope in this respect. As mentioned, in particular embodiments, such leakproof retaining of liquid material may be brought about via a manufacturing process, which may include RF welding, in which materials of circular base 1605 may be fused to a truncated cone-shaped wall of container 1602. In particular embodiments, circular base 1605 may comprise a diameter of between about 152 cm (about 5.0 feet) to about 213 cm (about 7.0 feet), although, again, subject matter is not limited in scope in these respects.

The embodiment of FIG. 16 also includes a plurality of straps 1610. In embodiments, the plurality of straps 1610 may individually comprise lengths of material (e.g., nylon and/or polyester) that may facilitate the lifting and/or suspension of container 1602. In embodiments, portions of straps 1610 may run underneath container 1602 and may provide a means by which container 1602 may be suspended, lifted, etc., such as by a crane, forklift, etc. In particular implementations, straps 1610 may be sewn onto lengths of polyvinyl chloride and/or tarpaulin, for example, that may go down one side of container 1602, may run along a bottom surface of circular base 1605 (e.g., may run underneath container 1602), and may go up an opposite side of container 1602. In implementations, the lengths of polyvinyl chloride and/or tarpaulin may be RF welded, for example, to container 1602. Thus, in implementations, portions of individual straps 1610 may be affixed to container 1602 and the non-fixed portions of straps 1610 may be available to facilitate lifting and/or suspension of container 1602.

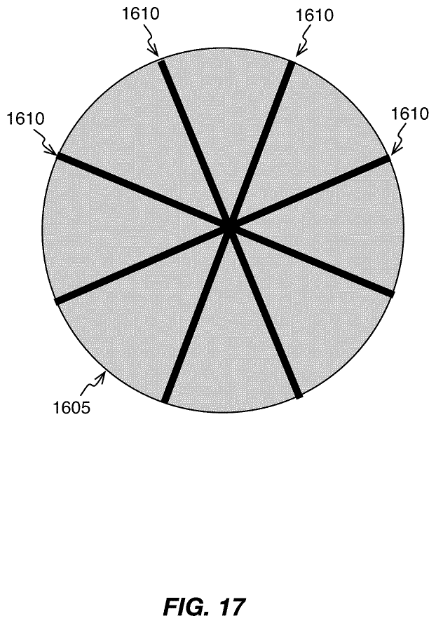

FIG. 17 depicts a bottom surface of circular base 1605 of container 1602. Also depicted in FIG. 17 are portions of straps 1610 running underneath container 1602 (e.g., affixed to the bottom surface of circular base 1605).

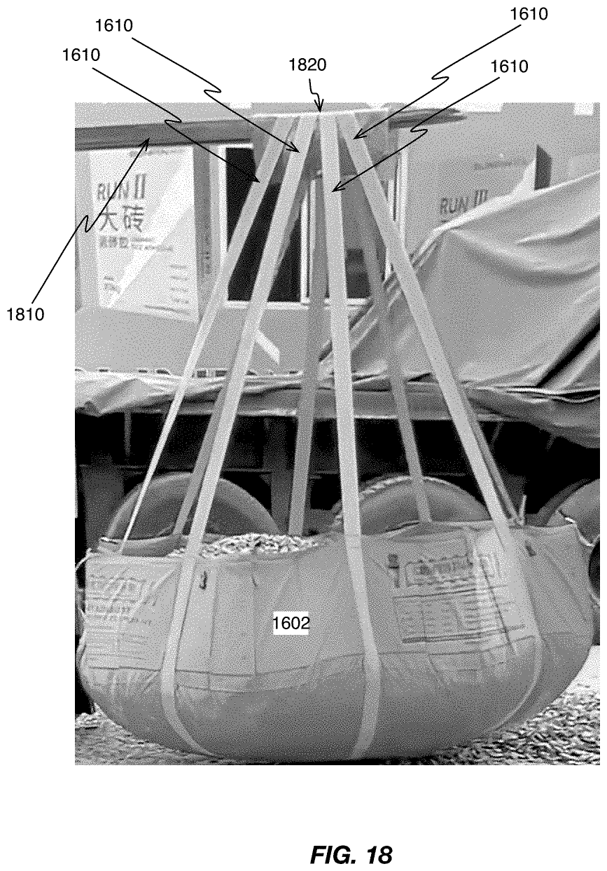

FIG. 18 depicts container 1602 being suspended from and/or lifted by a forklift 1810. As depicted, one or more of straps 1610 may individually comprise complete loops that may facilitate lifting and/or suspension of container 1602, although subject matter is not limited in scope in this respect. For example, in implementations, a pair of straps 1610 may be temporarily arranged into a loop by way of a buckle or some other fastener. In other implementations, straps 1610 may be permanently fixed into loops (e.g., via a manufacturing process). To lift container 1602, one or more forks of forklift 1810 may be inserted into the loops formed by straps 1610, and forklift 1810 may be operated to lift container 1602 by way of straps 1610 at a lift point 1820. Container 1602 may then relatively easily be moved as needed and/or desired.

In implementations, straps 1610 may individually be rated for particular break strengths for particular implementations of container 1602. For example, for a 5′ diameter container 1602, individual straps may be rated at 4k lbs. Also, for example, for a 7′ diameter container 1602, individual straps may be rated at 7k lbs. Of course, subject matter is not limited in scope in these respects.

Also, in embodiments, various numbers of straps may be utilized for various implementations of container 1602. For example, a container 1602 having a 5′ diameter may utilize six straps 1610 (e.g., forming three loops at lift point 1820) and a container 1602 having a 7′ diameter may utilize eight straps (e.g., forming four loops at lift point 1820). Again, subject matter is not limited in scope this these respects.

Unless otherwise indicated, in the context of the present patent application, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Likewise, the term “based on” and/or similar terms are understood as not necessarily intending to convey an exhaustive list of factors, but to allow for existence of additional factors not necessarily expressly described.

Furthermore, it is intended, for a situation that relates to implementation of claimed subject matter and is subject to testing, measurement, and/or specification regarding degree, that the particular situation be understood in the following manner. As an example, in a given situation, assume a value of a physical property is to be measured. If alternatively reasonable approaches to testing, measurement, and/or specification regarding degree, at least with respect to the property, continuing with the example, is reasonably likely to occur to one of ordinary skill, at least for implementation purposes, claimed subject matter is intended to cover those alternatively reasonable approaches unless otherwise expressly indicated. As an example, if a plot of measurements over a region is produced and implementation of claimed subject matter refers to employing a measurement of slope over the region, but a variety of reasonable and alternative techniques to estimate the slope over that region exist, claimed subject matter is intended to cover those reasonable alternative techniques unless otherwise expressly indicated.

To the extent claimed subject matter is related to one or more particular measurements, such as with regard to physical manifestations capable of being measured physically, such as, without limit, temperature, pressure, voltage, current, electromagnetic radiation, etc., it is believed that claimed subject matter does not fall with the abstract idea judicial exception to statutory subject matter. Rather, it is asserted, that physical measurements are not mental steps and, likewise, are not abstract ideas.

It is noted, nonetheless, that a typical measurement model employed is that one or more measurements may respectively comprise a sum of at least two components. Thus, for a given measurement, for example, one component may comprise a deterministic component, which in an ideal sense, may comprise a physical value (e.g., sought via one or more measurements), often in the form of one or more forces, signal samples and/or states, and one component may comprise a random component, which may have a variety of sources that may be challenging to quantify. At times, for example, lack of measurement precision may affect a given measurement. Thus, for claimed subject matter, a statistical or stochastic model may be used in addition to a deterministic model as an approach to identification and/or prediction regarding one or more measurement values that may relate to claimed subject matter.

For example, a relatively large number of measurements may be collected to better estimate a deterministic component. Likewise, if measurements vary, which may typically occur, it may be that some portion of a variance may be explained as a deterministic component, while some portion of a variance may be explained as a random component. Typically, it is desirable to have stochastic variance associated with measurements be relatively small, if feasible. That is, typically, it may be preferable to be able to account for a reasonable portion of measurement variation in a deterministic manner, rather than a stochastic matter as an aid to identification and/or predictability.

Along these lines, a variety of techniques have come into use so that one or more measurements may be processed to better estimate an underlying deterministic component, as well as to estimate potentially random components. These techniques, of course, may vary with details surrounding a given situation. Typically, however, more complex problems may involve use of more complex techniques. In this regard, as alluded to above, one or more measurements of physical manifestations may be modelled deterministically and/or stochastically. Employing a model permits collected measurements to potentially be identified and/or processed, and/or potentially permits estimation and/or prediction of an underlying deterministic component, for example, with respect to later measurements to be taken. A given estimate may not be a perfect estimate; however, in general, it is expected that on average one or more estimates may better reflect an underlying deterministic component, for example, if random components that may be included in one or more obtained measurements, are considered. Practically speaking, of course, it is desirable to be able to generate, such as through estimation approaches, a physically meaningful model of processes affecting measurements to be taken.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

What is claimed is:

1. A portable leak-proof container for substantially liquid and/or solid materials, comprising:
a substantially planar base having an outer circumference or perimeter that is substantially circular in shape; and
a plurality of panels abutting the substantially planar base, the plurality of panels being individually encased within a plurality of wall compartments of a wall having a truncated cone shape, wherein
the wall having the truncated cone shape is fused with at least the substantially planar base at the outer circumference or perimeter.

2. The portable leak-proof container of claim 1, wherein the wall having the truncated cone shape comprises an angle having a pitch of between 30° and 85° relative to the substantially planar base.

3. The portable leak-proof container of claim 1, wherein the wall having the truncated cone shape comprises an angle having a pitch of between 60° and 80° relative to the substantially planar base.

4. The portable leak-proof container of claim 1, wherein the wall having the truncated cone shape comprises an angle having a pitch of between 65° and 75° relative to the substantially planar base.

5. The portable leak-proof container of claim 1, wherein the wall having the truncated cone shape is fused with the substantially planar base via radio frequency welding.

6. The portable leak-proof container of claim 1, further comprising:
one or more fasteners, coupled to the wall having the truncated cone shape, to retain a cover over a top portion of the portable leak-proof container.

7. The portable leak-proof container of claim 1 further comprising:
one or more eyelets to accommodate a corresponding number of stakes, the corresponding number of stakes to restrict movement of the portable leak-proof container with respect to a supporting surface.

8. The portable leak-proof container of claim 1, wherein the wall having the truncated cone shape comprises a material having a tensile strength of between about 6700 N (about 1500 pounds) and 13,500 N (about 3113 pounds).

9. The portable leak-proof container of claim 1, wherein the portable leak-proof container is suitable for retaining concrete suspended in a liquid medium or for containing a slurry material.

10. The portable leak-proof container of claim 1, wherein the plurality of panels abutting the substantially round base are substantially rectangular in shape.

11. The portable leak-proof container of claim 1, further comprising:
a plurality of straps, wherein for individual straps of the plurality of straps, a portion is affixed to at least the substantially planar base.

12. The portable leak-proof container of claim 11, wherein for individual straps of the plurality of straps, an additional portion is affixed to one or more of the plurality of panels abutting the substantially planar base.

13. The portable leak-proof container of claim 11, wherein for individual straps of the plurality of straps, an additional portion is affixed to the wall having the truncated cone shape.

14. The portable leak-proof container of claim 11, wherein one or more of the plurality of straps comprise a loop.

15. The portable leak-proof container of claim 11, wherein the plurality of straps comprise nylon or polyester, or a combination thereof.

16. The portable leak-proof container of claim 11, wherein the plurality of straps are affixed to the substantially planar base and/or at least one of the plurality of panels abutting the substantially planar base via respective lengths of polyvinyl chloride and/or tarpaulin RF welded to the substantially planar base and/or at least one of the plurality of panels abutting the substantially planar base, wherein the plurality of straps are sewn onto the respective lengths of polyvinyl chloride and/or tarpaulin.

17. The portable leak-proof container of claim 11, wherein the substantially planar base comprises a diameter of approximately five feet and wherein the plurality of straps comprise six straps.

18. The portable leak-proof container of claim 17, wherein the six straps are arranged into three loops.

19. The portable leak-proof container of claim 11, wherein the substantially planar base comprises a diameter of approximately seven feet and wherein the plurality of straps comprise eight straps.

20. The portable leak-proof container of claim 19, wherein the eight straps are arranged into four loops.

21. The portable leak-proof container of claim 1 further comprising:
a self-erecting moisture-shedding cover to be placed in contact with the substantially planar base.

22. The portable leak-proof container of claim 21, wherein the self-erecting moisture-shedding cover comprises two or more flexible ribs, the two or more flexible ribs being prestressed to maintain an arc or dome shape responsive to deployment.

23. The portable leak-proof container of claim 21, wherein the self-erecting moisture-shedding cover comprises a skirt which operates to provide a path for moisture shedding below a lip of the substantially planar base.

24. The portable leak-proof container of claim 22, wherein the two or more flexible ribs crossover at a crossover location at a base portion of the self-erecting moisture-shedding cover.

25. The portable leak-proof container of claim 24, further comprising a tensioner to retain in place the two or more flexible ribs at the crossover location at the base portion of the self-erecting moisture-shedding cover.

26. The portable leak-proof container of claim 1, wherein the portable leak-proof container comprises at least a substantial percentage of polyvinyl chloride (PVC) and/or at least a substantial percentage of tarpaulin.

27. A method for erecting a container for debris, the method comprising:
unfolding, substantially without use of machinery or equipment, the container from a substantially compressed to a substantially uncompressed state; and
positioning the container at a location for intended use and without insertion of additional structural elements.

28. The method of claim 27, wherein positioning the container at the location comprises grasping and/or pulling on one or more straps to relocate the container.

29. A method for forming a container to accommodate debris or other material, the method comprising:
disposing a plurality of substantially rectangular-shaped panels into a wall having a truncated cone shape; and
fusing the wall to a planar and substantially circular base so as to form a substantially leak-proof seal at one or more fusing points and/or seams.

30. The method of claim 29, wherein the one or more fusing points and/or seams are between the wall and the substantially circular base.

31. The method of claim 29, wherein the fusing the wall to the planar and substantially circular base comprises radio frequency welding the wall to the planar and substantially circular base.

32. The method of claim 29, wherein the disposing the plurality of substantially rectangular-shaped panels comprises disposing corrugated plastic rectangular-shaped panels into the wall having the truncated cone shape.

33. The method of claim 29, further comprising erecting the wall having the truncated cone shape at a pitch of between about 30° and 85° relative to the planar and substantially circular base.

34. The method of claim 29, further comprising erecting the wall having the truncated cone shape at a pitch of between about 60° and 75° relative to the planar and substantially circular base.

35. The method of claim 29, further comprising refraining from inserting any additional structural components into the container to accommodate the debris.

36. The method of claim 29, further comprising:
allowing the container to accommodate the debris to unfold itself without substantial user input.

37. The method of claim 29, further comprising:
displacing the container responsive to grasping one or more straps of the container.

38. The method of claim 37, wherein the displacing the container responsive to the grasping of the one or more straps of the container comprises operating a forklift and/or a crane to lift a plurality of straps of the container.

39. The method of claim 29, further comprising forming a plurality of straps to facilitate lifting and/or suspension of the container.

40. The method of claim 39, wherein the forming the plurality of straps includes:
sewing the plurality of straps to respective lengths of polyvinyl chloride and/or tarpaulin; and
affixing the respective lengths of polyvinyl chloride and/or tarpaulin to at least the substantially circular base.

41. The method of claim 40, wherein the forming the plurality of straps further includes affixing the respective lengths of polyvinyl chloride and/or tarpaulin to the wall having the truncated cone shape.

42. The method of claim 39, wherein the forming the plurality of straps further includes forming the plurality of straps of nylon and/or polyester.

43. The method of claim 29, further comprising forming a self-erecting moisture-shedding cover for placement over the container to accommodate debris or other material.

44. A portable leak-proof container and a self-erecting moisture-shedding cover, comprising:
a base portion, the base portion having a crossover of two or more structural ribs, the two or more structural ribs extending from the base portion to an apex portion of the self-erecting moisture-shedding cover, an area between two or more structural at the apex portion of the self-erecting moisture-shedding cover providing an open region to channel liquid incident at the apex portion of the self-erecting moisture-shedding cover.

45. The self-erecting moisture-shedding cover of claim 44, wherein the two or more structural ribs are prestressed so as to form the apex portion of the self-erecting moisture-shedding cover substantially without user manipulation.

46. The self-erecting moisture-shedding cover of claim 44, wherein: the two or more structural ribs define an arc or dome shape.

47. The self-erecting moisture-shedding cover of claim 44, wherein the two or more structural ribs are held into place by a tensioner at opposed sides of the base portion of the self-erecting moisture-shedding cover.

48. The self-erecting moisture-shedding cover of claim 44, wherein the base portion includes provisions for fastening the self-erecting moisture-shedding cover to a circle-shaped container.
